(19) United States
(12) Patent Application Publication
(10) Pub. No.: US 2005/0198902 A1
(43) Pub. Date: Sep. 15, 2005

(54) Storage silo closure apparatus

(75) Inventor: Alan Robert Meyer, Kyabram (AU)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Danieli & Meyer Produce & Grain Pty Ltd, Kyabram (AU)

(21) Appl. No.: 11/076,704

(22) Filed: Mar. 10, 2005

(30) Foreign Application Priority Data
Oct. 1, 2004 (AU) 2004 216662
Oct. 7, 2003 (AU) 2003 905411

(51) Int. Cl. E05F 11/02; B65D 43/26

(52) U.S. Cl. 49/279; 220/262; 220/345.1; 49/345; 52/192

(57) ABSTRACT

A closure apparatus (1) for covering an opening (2) in a storage tank comprising:
(a) a connector to connect the apparatus to the silo in the proximity of the opening (2);
(b) a cover (10) to cover the opening (2), said cover having a projection (11) forming a leading edge of the cover (10),
(c) an elongate guide member having a guide surface (13a, 14a), the cover (10) being slidingly engaged with the guide member and movable along the guide surface (13a, 14a) from a first position adjacent the opening (2) to a second position covering the opening (2); and
(d) an actuator (4,5) to move the cover between the first position and the second position;
   wherein the projection (11) removes debris on the guide surface (13a, 14a) during movement between the first position and the second position.

### FIELD OF THE INVENTION

The invention relates to an apparatus for closure of storage tanks.

### BACKGROUND OF THE INVENTION

In this specification where a document, act or item of knowledge is referred to or discussed, this reference or discussion is not an admission that the document, act or item of knowledge or any combination thereof was at the priority date publicly available, known to the public, part of the common general knowledge or known to be relevant to an attempt to solve any problem with which this specification is concerned.

Storage tanks are used in various industries to store liquids such as water and chemicals and particulate material such as grains, milled grains (such as flour), stock feeds, etc. Such tanks have separate openings to facilitate filling and emptying. The filling opening is usually near the top of the tank so that the liquid particulate material is able to fill to the maximum extent. In this specification, storage tanks used to store particulate material are referred to as silos.

It is often necessary to run an auger for a lengthy period of time when filling a silo. During this period, the grain or other particulate material which does not fall directly into the silo opening tends to collect and pile up around the edges of the opening. This particulate debris interferes with the closure used to cover the filling opening. Similarly, if a tank is used to store viscous material, it can also build up around the opening and interfere with the closure used to cover the filling opening.

Silo and tank filling openings have traditionally been covered with manually operated hinged covers. Thus, it has been necessary for the operator to climb up the silo to manually cover and uncover the opening. This presents a safety hazard as there is a risk that the operator will fall. Operators have traditionally had to remove debris from around the tank or silo opening manually. More recently, there have been attempts to provide covers for the filling opening which can be operated from the ground without the need to climb up the tank or silo. However, such devices are still inadequate as they tend to become clogged with the particulate material. Thus, the operator must still regularly climb the tank or silo in order to clean and maintain the device so that it will work. Therefore there is a need for a closure apparatus for a storage silo which enables remote operation and which minimises the incidence of jamming with the particulate material being stored in the silo.

### SUMMARY OF THE INVENTION

Accordingly, the present invention provides a closure apparatus for covering an opening in a storage tank comprising:
1 a connector to connect the apparatus to the silo in the proximity of the opening;
2 a cover to cover the opening, said cover having a projection forming a leading edge of the cover,
3 an elongate guide member having a guide surface, the cover being slidingly engaged with the guide member and movable along the guide surface from a first position adjacent the opening to a second position covering the opening; and
4 an actuator to move the cover between the first position and the second position;
   wherein the projection removes debris on the guide surface during movement between the first position and the second position.

The projection from the cover is a particularly useful feature of the present invention. This projection removes debris from the guide surface during movement of the cover. It is possible to adapt the projection of the present invention in such a way so that substantially all of the debris (such as particulate material) on the guide surface is removed during movement of the cover. Such adaptations may relate to various aspects of the projection such as its proximity to the guide surface, its placement on the cover, the angle at which it is directed in comparison with the direction of the plane of the guide surface, its polarity relative to the debris or any other suitable characteristic.

In a simple form of the projection, it extends laterally only so far as the width of the guide surface. It will be appreciated that this width is sufficient to remove debris from the guide surface. However, other variations in the width of the projection are also within the scope of this invention. For example, according to one particularly preferred embodiment in which the cover extends between two guide members, the projection extends across the width of the cover from the lateral-most aspect of one guide surface to the lateral most aspect of the other. This embodiment has the advantage that it is cost efficient to manufacture. For example, such a projection can be produced by bending the leading edge of the cover to a position approximately perpendicular to the plane of the cover.

According to another preferred embodiment, the cover comprises a sliding member which is slidingly engaged with the guide surface. When formed from an appropriate material, such a sliding member will reduce wear and tear on the guide member and the cover and decrease friction between them. Such a sliding member may be made from any suitable material, for example, polymers such as nylon, bakelite or teflon have been found to be an excellent choice. The sliding member may be attached to the cover by any suitable means eg metal rivets or other fasteners. In this event, the fastener will preferably be spaced from the guide surface.

As the sliding member according to this embodiment is slidingly engaged with the guide surface, it will assist removal of debris from the guide member during movement of the cover between the first position and the second position. According to this embodiment, the projection is not directly engaged with the guide surface. However, the projection still removes debris which becomes piled on the guide surface during filling of the tank or silo. Therefore, in this embodiment, the projection removes most of the pile of debris and the sliding member removes the debris which is closest to the guide surface. Thus, according to this embodiment, where there is little debris to be removed, the sliding member will remove all of it.

The sliding member and the projection according to this embodiment may be arranged so that they effectively form a single surface which removes debris. However, equally they may be arranged in other ways. For example, the projection may project beyond the sliding member so that it will first contact the pile of debris and remove most of it, leaving the remaining much smaller amount of debris to be removed by the sliding member as it follows behind.

At this stage, it is not clear if the debris removal is purely a mechanical action or an electrical field action or a combination of both. Grain dust is highly electrostatic and therefore it is possible that some of the debris may be repelled from the projection if it has a similar or a like polarity.

Preferably the actuator acts remotely. Thus, rather than simply being a handle on the cover, a remote actuator allows a person who is not adjacent the opening in the tank or silo to operate the apparatus and thereby cover or uncover the opening in the tank or silo. This is of particular benefit where the opening which is to be covered or uncovered is positioned some distance from the ground. This is very commonly the case with openings which are used to fill the tank or silo. A tank or silo closure apparatus with an actuator on the ground which operates a cover on the top of a tall tank or silo reduces the safety hazard entailed in climbing the tank or silo to open or close the cover. The actuator can be of any suitable type. For example, it may be a pulley, a piston, a screw, a lever etc.

One particularly preferred form of remote actuator operates using a pulley system. Such an actuator can be operated by a person situated remotely from the opening in the tank or silo (such as standing on the ground), and is relatively economical to manufacture. According to this embodiment, the pulley may be attached either to the closure apparatus (for example on a frame surrounding the cover or comprising the guide members) or to the tank or silo itself. Preferably a pulley is provided on both in front of the leading side and behind the rear side of the cover to enable the cover to be readily moved both towards and away from the tank or silo opening. According to a preferred form of this embodiment, the pulley rope (preferably a synthetic (plastic) or synthetic (plastic) covered rope eg nylon coated) passes upwards from the base of the tank or silo and through the first pulley, across the cover, to which it is attached, through the second pulley and then back down to the base of the tank or silo. The operator can close or open the cover by pulling one or the other of the ends of the pulley rope.

It should be noted that other remote actuators also form part of this invention. For example, actuators which are motorised and can be activated by a switch near the base of the tank or silo can be used.

According to another preferred embodiment, the elongate guide member comprises elongate guide rails. In use, such guide rails preferably pass either side of the opening. A closure apparatus according to this embodiment provides enhanced stability for the cover as it travels along the guide members by having multiple areas of support over its travel distance.

Preferably the guide rails are provided as complementary pairs of sub guide rails. Each pair of sub guide rails may also comprise an upper rail and a lower rail. The cover is slidingly engaged therebetween. Thus the cover can be effectively trapped between each pair of rails and further stabilised. Such stabilisation is particularly useful against the lifting forces of wind travelling between the cover and the tank or silo. However, it is not necessary for the working of the invention that there be an upper guide rail. The cover may equally be stabilised by other methods. For example, in some embodiments, the downward forces imparted by the pulley rope will be sufficient to counteract the lifting forces of wind. In other embodiments, the weight of the cover is sufficient to maintain the cover in engagement with the guide surface.

According to another preferred embodiment, the cover comprises at least one lateral projection. Such lateral projections can provide structural stability. Typically, the lateral projections engage the guide member to further stabilise the cover during movement between the first position and the second position. A lateral projection according to the present invention may take any suitable form, however, preferably it comprises a lip on the lateral edge of the cover. Such a lip may be adapted to slidingly engage the guide member to further stabilise the cover. Preferably such a lip engages the lateral aspect of the guide member.

In another embodiment, the lateral projection is adapted to engage a lower surface of the guide member. This embodiment provides extra stabilisation of the cover against lifting forces. Typically, the lateral projection is a lip which is bent so as to conform with the shape of the guide member (such as a guide rail). Where a guide rail is used, the lip effectively curls around the guide rail so that it engages the lower surface of the guide rail. Thus such closure apparatus does not require an upper guide rail as the cover is stabilised against the lower guide rail by the lateral projection.

The connector may be of any suitable form. The connector should provide sufficient connection between the apparatus of the invention and the tank or silo to ensure that the apparatus works. Thus, for example, the connector must be able to withstand forces applied to the cover via the actuator (such as a pulley system). Suitable connectors may include standard mechanical means, for example, bolts, screws, welding, etc. The connector may also provide a stabilising or structural function. For example, it may comprise stabilising members which connect various components of the apparatus (for example the sets of guide rails).

A particularly useful aspect of the present invention lies in the manner in which the apparatus can be attached to the tank or silo. In particular, it is possible to design the apparatus in such a way so that it does not interfere with placement of a ground-based filling apparatus above the opening, such as the mobile augers commonly used on farms. The present invention may provide a closure apparatus with a profile which is sufficiently low to achieve these aims. Unless an overly long auger is used to fill the silo, the auger tip or barrel would be unable to hit the apparatus of the present invention.

In a particularly preferred embodiment, the cover further comprises a seal member to create a seal around the opening. Such a seal may be of a variety of forms depending on the particular situation. For example, if it is necessary to decrease dust or other debris which escapes from the opening, then a simple seal will be sufficient. A simple seal according to this embodiment may be of any suitable type, for example, it may comprise a rubber flange which extends upwardly from the rim around the tank or silo opening and engages with the cover in its closed position. However, in certain circumstances, a tighter seal may be required. For example, a gas-tight seal may be required where the tank or silo is to be fumigated to eliminate insect pests. A seal according to this aspect of the invention is most preferably operable remotely and preferable operation of the actuator will cause it to engage and seal the tank or silo opening. According to one preferred embodiment of this aspect of the invention, the cover comprises a body, a plate, a resilient member and a seal, the plate being movably engaged with the body of the cover, the seal being mounted on the plate and the resilient member arranged so as to bias the plate towards the underside of the body of the cover such that when the cover is in the second position, compression of the resilient member causes the plate and seal to form a sealing engagement with the tank opening.

According to a further preferred embodiment, the cover comprises a second seal interleaved between the body and the plate to further improve the sealing engagement. According to a particularly preferred embodiment, the plate and the seals are disc-shaped and threadably engaged about their axes with a rod which passes through the centre of the body of the cover. According to this embodiment the resilient member is a spring which is attached to a pulley. Operation of the pulley causes the spring to be compressed, which draws the plate and seals away from the body of the cover and into sealing engagement with the rim of the tank or silo opening. The plate and seals are held in sealing engagement by locking the pulley rope in this position. This may be done by any suitable means, for example, it may involve tying off the rope or threading it through a locking member.

The apparatus of the present invention may be used in respect of any of the openings on a tank or silo. However, it is particularly useful in providing a closure for the opening through which the tank or silo is filled. Such an opening is usually near the top of the tank or silo. Similarly, the apparatus of the present invention may be used to cover a variety of different shaped openings, including (but not limited to) square, circular, and polygonal openings.

The closure apparatus according to this invention may be incorporated into the manufacture of a tank or silo prior to sale of the tank or silo. However, the apparatus may equally be added to tank or silos already in use.

The word ‘comprising’ and forms of the word ‘comprising’ as used in this description does not limit the invention claimed to exclude any variants or additions.

Modifications and improvements to the invention will be readily apparent to those skilled in the art. Such modifications and improvements are intended to be within the scope of this invention.

### DESCRIPTION OF THE DRAWINGS

The invention will now be further described in relation to the figures in which:

FIG. 1 is a perspective view of an apparatus according to the present invention in the open position.

FIG. 2 is a perspective view of an apparatus according to the present invention in the closed position.

FIG. 3 is a plan view of the apparatus of FIG. 1.

FIG. 4 is a plan view of the apparatus of FIG. 2.

FIG. 5 is a side view of the apparatus of FIG. 1.

FIG. 6 is a side view of the apparatus of FIG. 2.

FIG. 7 is a front view of an apparatus according to the present invention.

FIG. 8 is a photograph of an auger positioned adjacent a storage silo to which a closure apparatus according to the present invention has been attached.

FIG. 9 is an exploded view of a cover and sealing embodiment of the invention.

FIG. 10 is a perspective view of the apparatus of FIG. 9 in which the cover is in a closed position.

FIG. 11 is a perspective view of the apparatus of FIG. 9 in which the cover is in an open position.

FIG. 12 is a side view of the apparatus of FIG. 10.

FIG. 13 is a side view of the apparatus of FIG. 11.

FIG. 14 is a cut-away view of the apparatus of FIG. 11.

FIG. 15 is a cut-away view of the apparatus of FIG. 10.

FIG. 16 is a perspective view of an apparatus according to the invention in which the cover is open.

FIG. 17 is a side view of the apparatus of FIG. 16.

FIG. 18 is a perspective view of the apparatus of FIG. 16 in which the cover is closed.

FIG. 19 is a side view of the apparatus of FIG. 18.

FIGS. 20a and 20b are perspective views of the apparatus of FIG. 16 in which the cover is in sealing engagement with the silo opening with and without a rope.

FIG. 21 is a side view of the apparatus of FIG. 20.

### The description of the preferred embodiments in the Figures is provided by way of example only and is not intended to be limiting in any way.

### DETAILED DESCRIPTION OF THE INVENTION

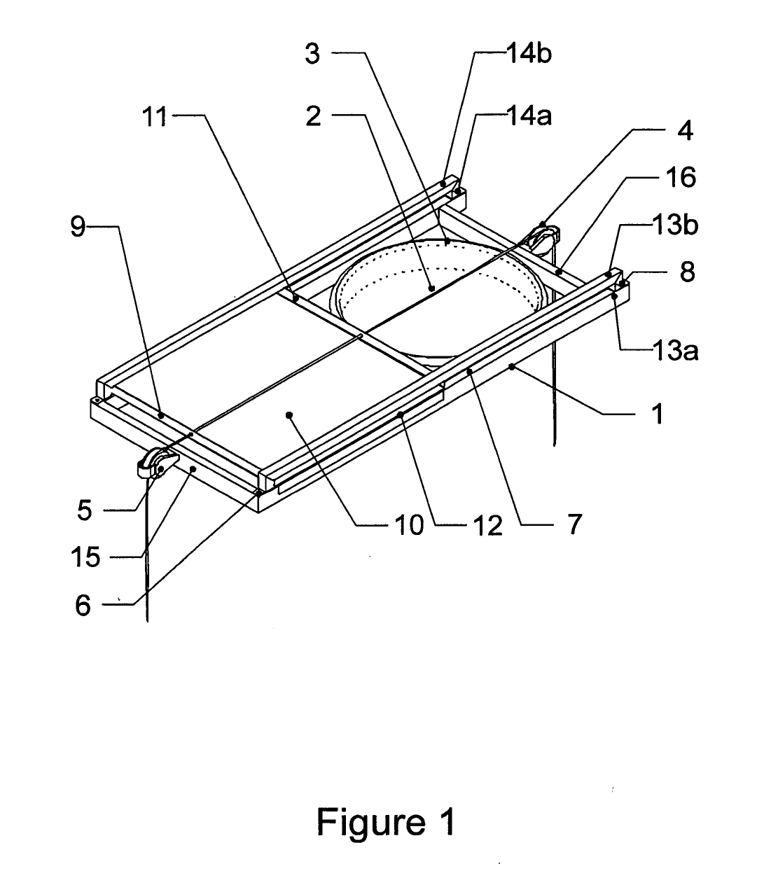

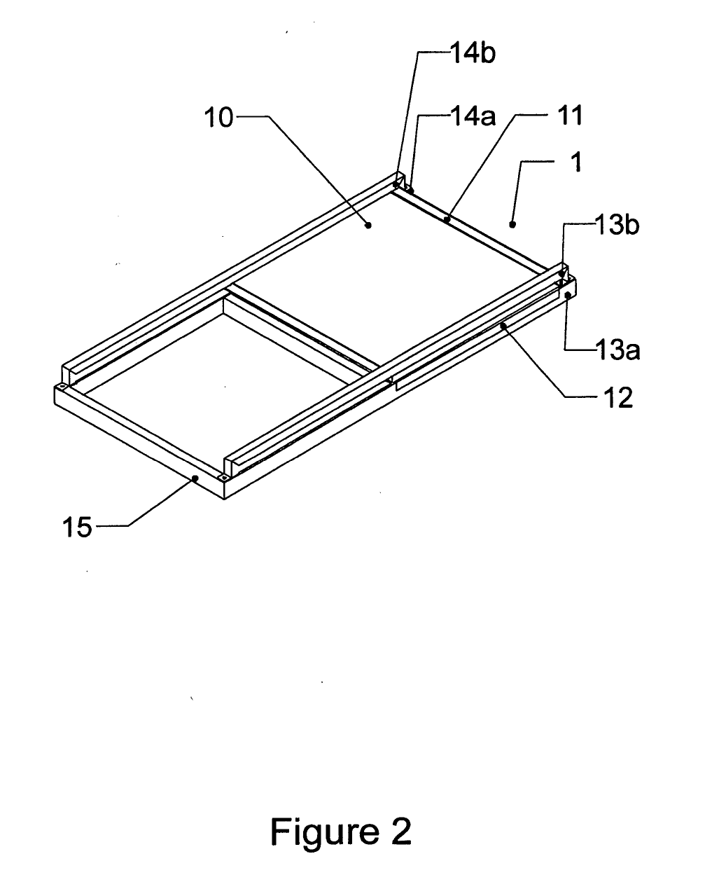

FIGS. 1 and 2 depict an apparatus according to the present invention in the open and closed positions respectively. The apparatus is shown generally at 1. Apparatus 1, is fitted around opening 2 in the silo (not shown). Opening 2 has a rim 3. Apparatus 1 includes pulley 4 (mounted on stabilising member 16) and pulley 5 (mounted on stabilising member 15) which are part of the actuator for causing movement of cover 10. Pulleys 4 and 5 have guards or stirrups (not shown) which act to keep the rope from slipping off the pulleys.

Cover 10 has lip 11 which is the leading edge of cover 10. Cover 10, is slidingly engaged with guide surface 7 of guide rail 13a via a nylon strip (not shown). This sliding engagement enables the combination of the nylon strip and lip 11 to cause substantially all particulate (and other) material to move off the guide surface and thus minimise the chances of jamming. Cover 10 of this embodiment also has lip 9 which can act to cause debris to be removed from the guide rails during movement of the cover from the closed to the open position.

Guide rail 13a together with guide rail 13b comprise one side of the guide member. Although it is not illustrated, the underside of cover 10 is covered with a strip of nylon which engages with guide surfaces of guide rails 13a and 14a.

Guide rails 13a, 13b, 14a and 14b run parallel to each other and either side of opening 3. Guide rails 13a and 14a are adjacent to the inside face of cover 10 and guide rails 13b and 14b are adjacent the outside face of cover 10. Cover 10 also has lateral projection 12 which is folded down over guide rail 13a to engage it and assist to guide cover 10.

Apparatus 1 is connected to the silo (not shown) by means of bolts which pass through holes (not shown) such as through stabilising member 16, guide rails 13a and 14a as well as a further stabilising member mounted approximately across the centre of the apparatus (not shown). Bolts are placed through holes 6 and 8 (and similar holes on guide rail 14a) to attach the upper guide rail (13b or 14b) to the lower guide rail (13a or 14a).

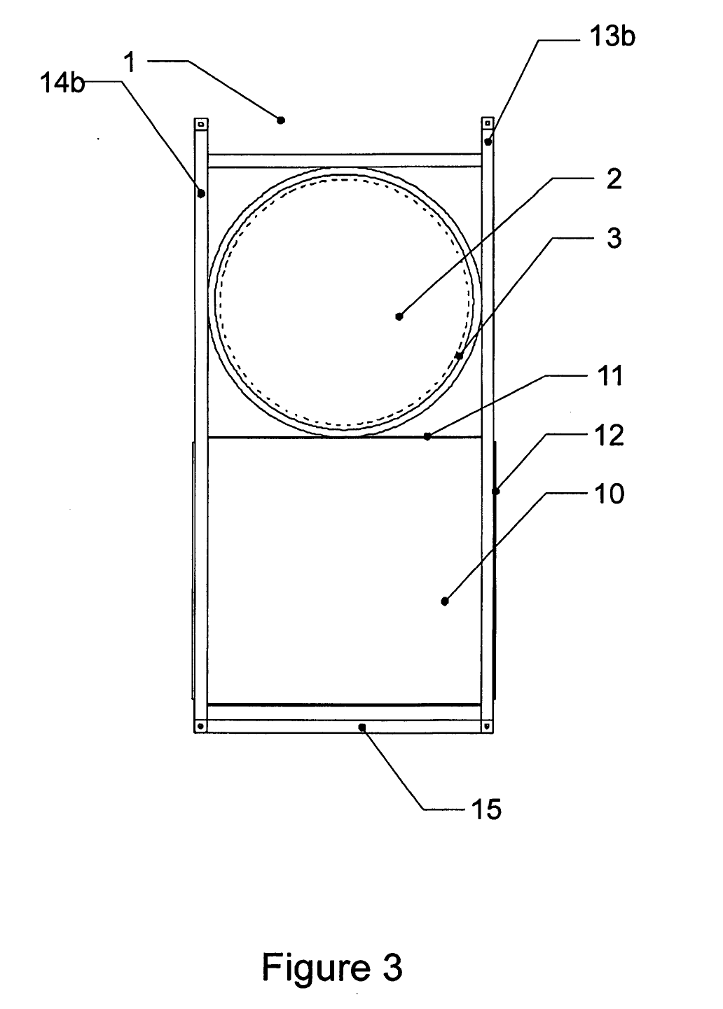

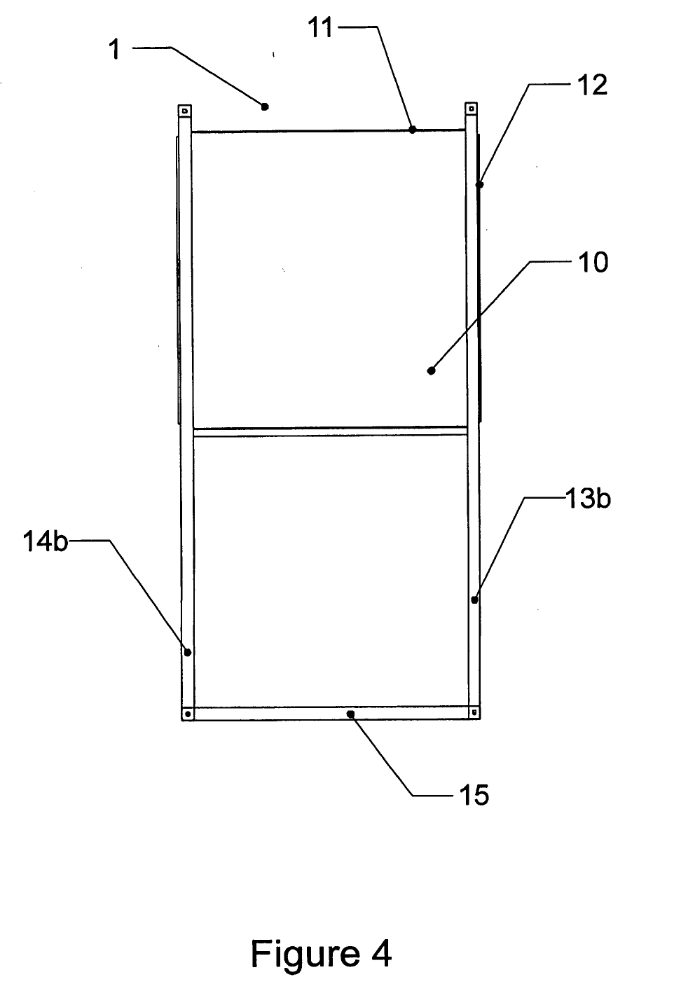

FIGS. 3 and 4 depict plan views of the apparatus of FIGS. 1 and 2. Lateral projection 12 is visible as it projects slightly beyond the lateral surface of guide rail 13a in order to engage it. Although it is not shown, a similar lateral projection engages guide rail 14a.

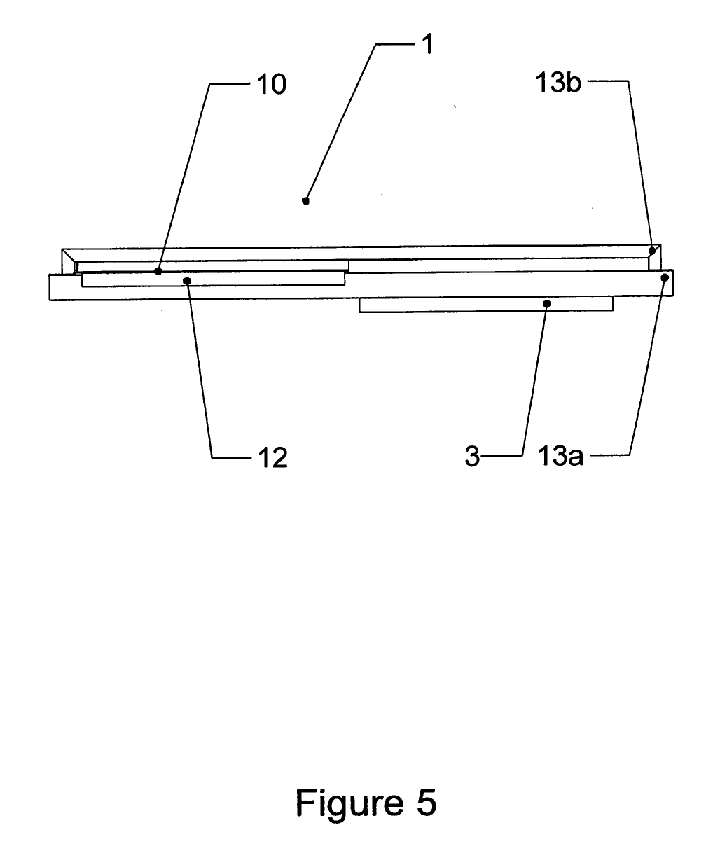

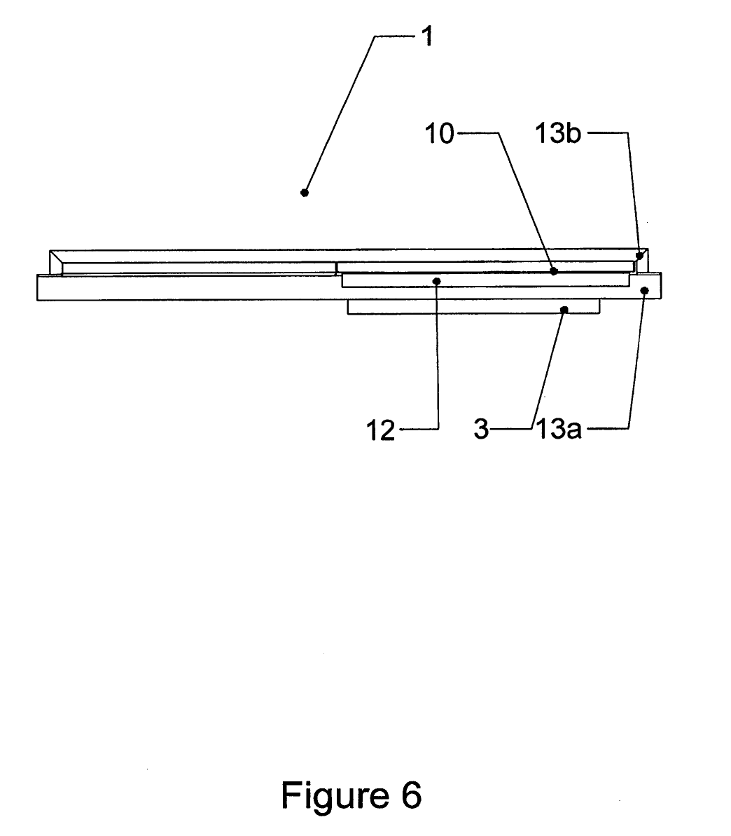

FIGS. 5 and 6 depict side views of the apparatus as shown in FIGS. 1 to 4.

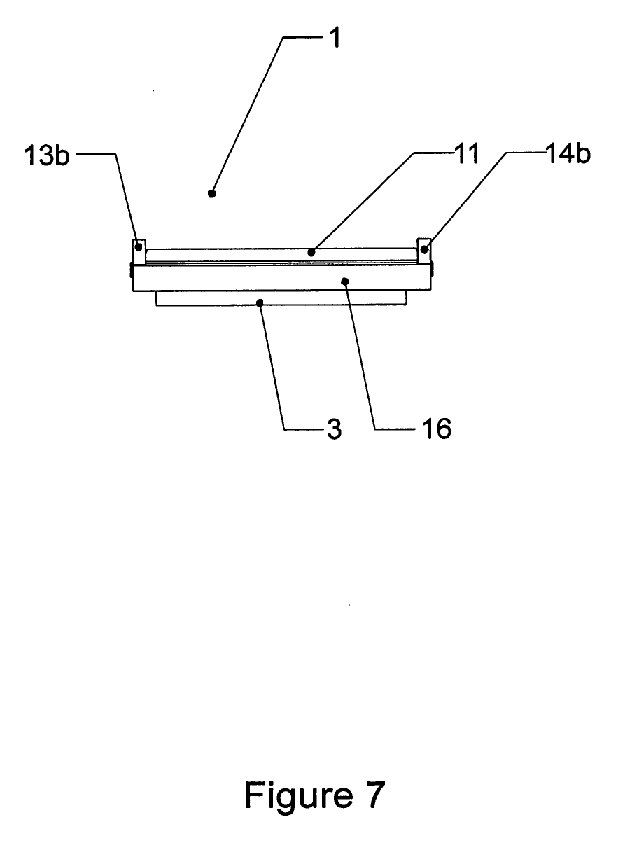

FIG. 7 depicts a front view of apparatus 1. This demonstrates the height of lip 11. However, it is not necessary that the lip be this height. It is only necessary that the height of the lip be sufficient so as to sweep the particulate material from the guide surfaces rather than allowing it to slide up onto the top of the cover 10.

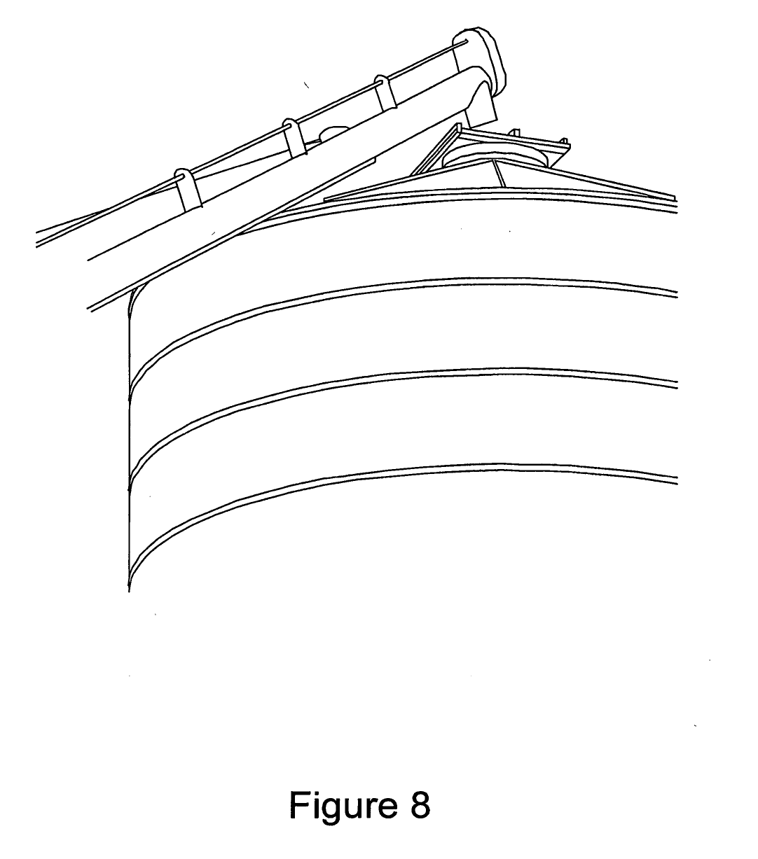

FIG. 8 depicts an auger positioned adjacent a storage silo to which a closure apparatus according to the present invention has been attached. It can be seen that the closure apparatus is positioned on the silo in such a way that the auger is not inhibited from being positioned over the silo opening. In fact, as can be seen from FIG. 8, the auger can not engage the closure apparatus itself as it will first contact and be restrained by the vertical side of the silo.

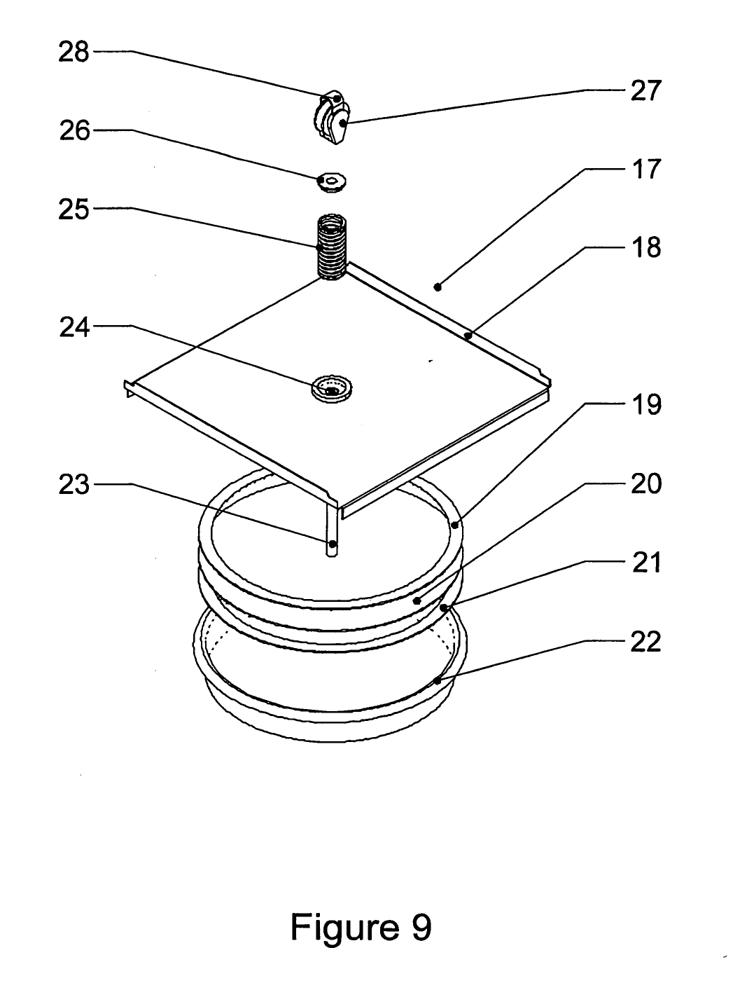

FIG. 9 depicts an exploded view of a further embodiment of the apparatus of the present invention shown generally at 17. The cover has a body 18, and comprises seal (gasket) 19, plate 20 and seal (gasket) 21 which are attached at their axes on rod 23 which passes through aperture 24 in body 18 of the cover. Spring 25 is also threaded over rod 23 and washer 26 sits between spring 25 and pulley 27. Pulley 27 is attached to the top of rod 23. Pulley 27 has guard 28 to stop the rope from being pulled out of the pulley.

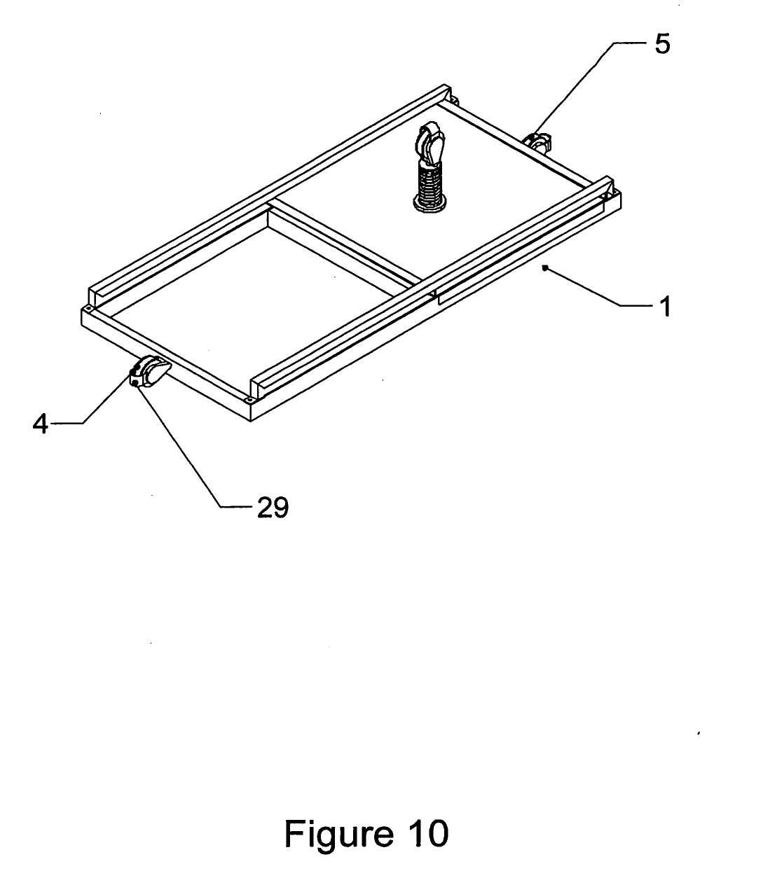

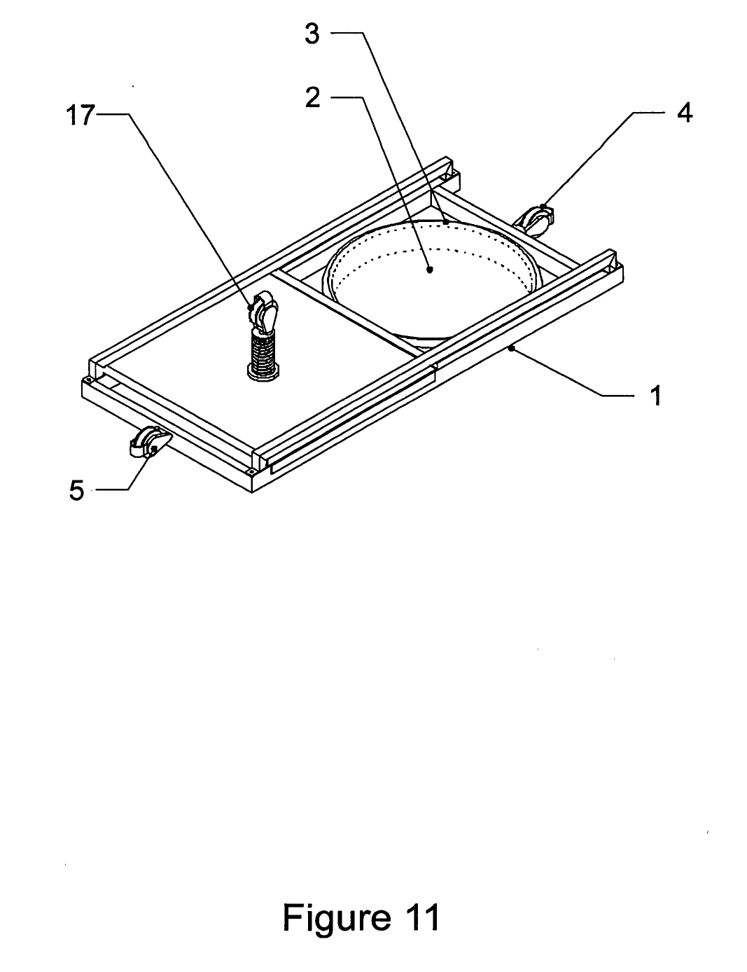

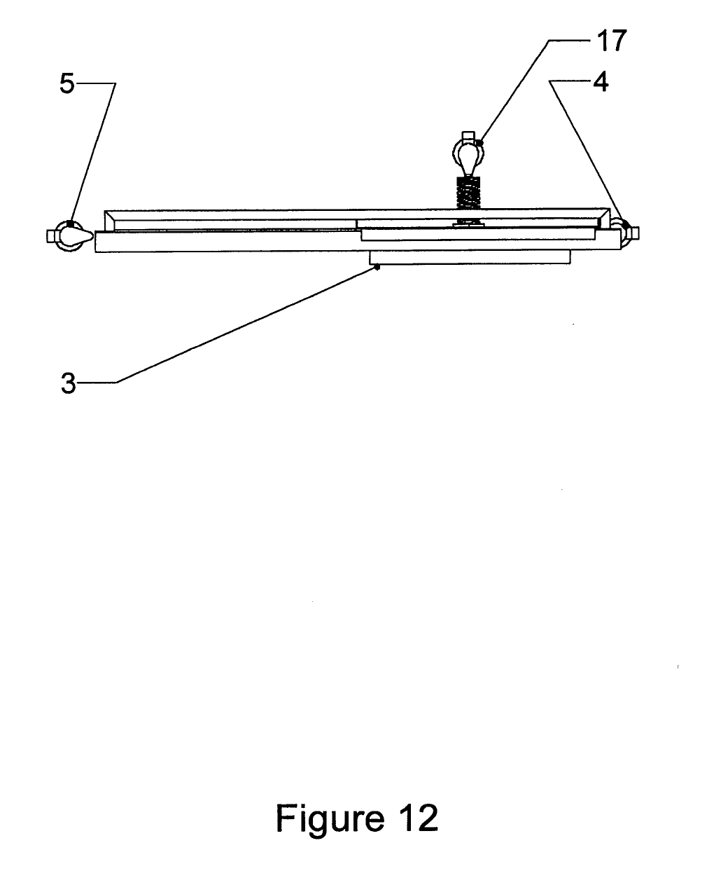

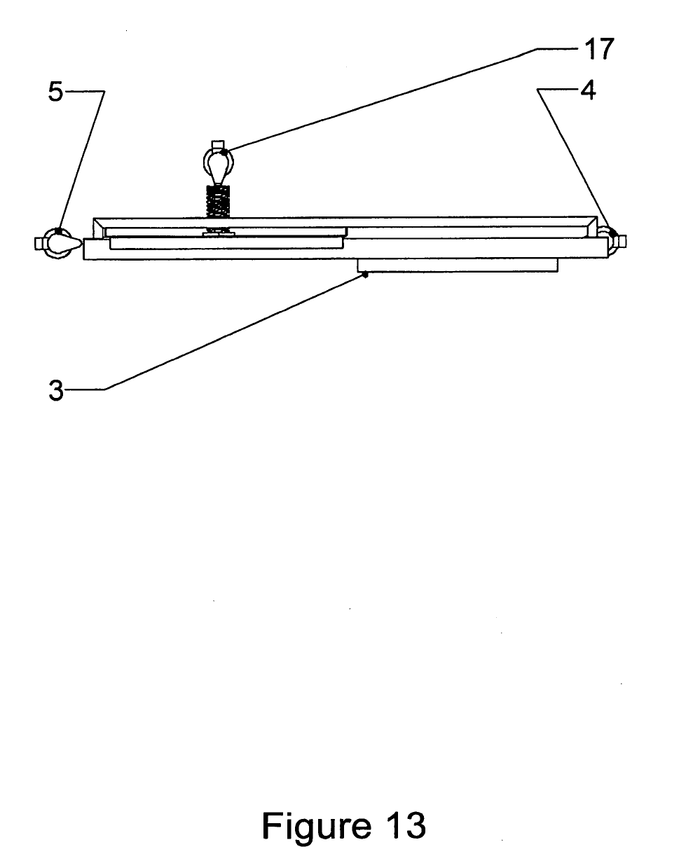

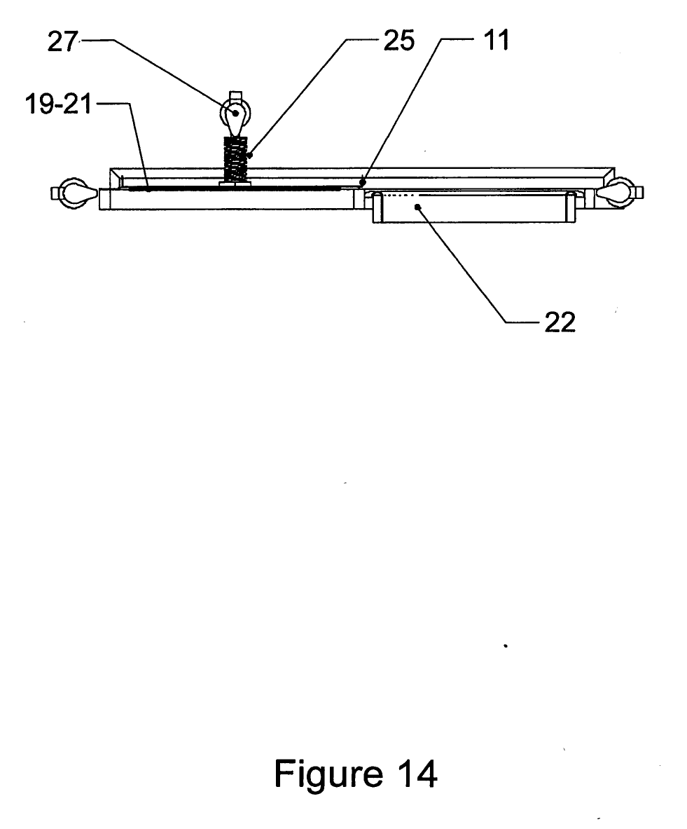

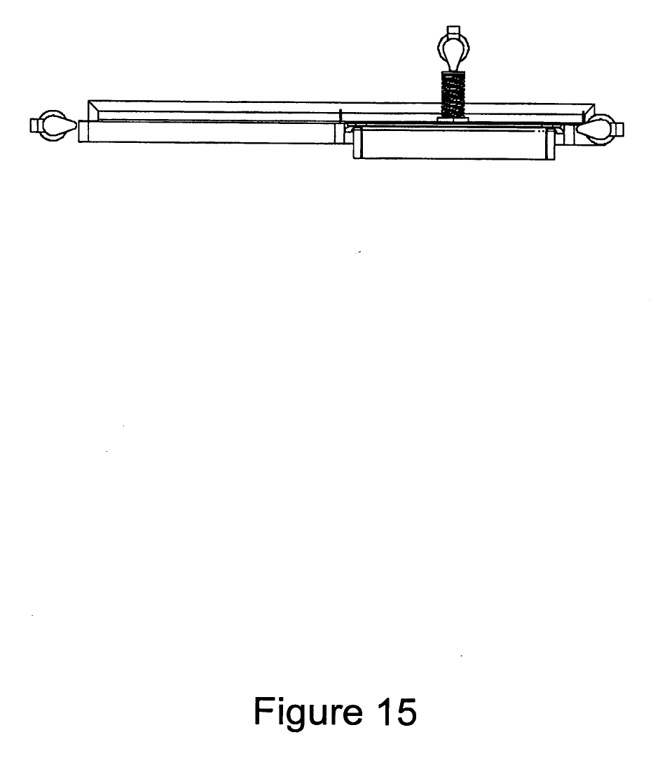

FIG. 10 depicts pulley 5 or 6 (as per FIG. 1) with guard 29. FIG. 14 demonstrates a cut-away view of the apparatus of FIG. 9 in the open position in which the cover is shown with leading edge 11 and comprising seals and plate 19, 20 and 21. Spring 25 and pulley 27 are also visible as is the cut-away view of rim 22 of the tank opening.

In operation, pulleys 4 and 5 as depicted in FIG. 1 are first used to move the cover between the first (open) and second (closed) positions. For example, the rope (preferably plastic coated eg with nylon) extending from pulley 4 is used to move the cover to the closed position (as in FIG. 10). This rope is then tied off on a suitable part of the silo or tank, such as a handle or other item. The rope attached to pulley 27 is then pulled tight which causes spring 25 to be compressed and thereby move plate and seals 19, 20 and 21 into sealing engagement with rim 22. According to this embodiment, this rope must be held in the extended position so as to continue to maintain the spring in the compressed state. This can be achieved by tying off the rope or locking it on a suitable apparatus affixed to the silo or tank.

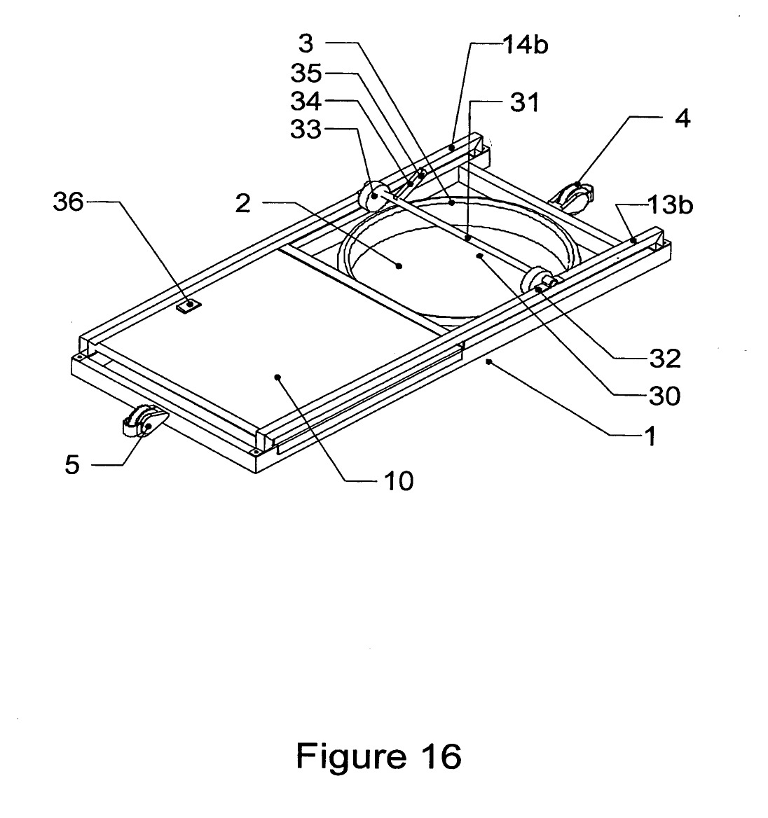

FIGS. 16 to 21 depict an alternate method of causing cover 10 to sealingly engage the silo opening 2. A cam based device 30 is shown which comprises a rod 31 extending across the opening 2. Each end of the rod 31 is affixed to guide rails 13b and 14b by a U-bracket 32 but may rotate within those brackets. A pair of cams 33 are mounted on rod 31. Projecting from rod 31 is an arm 34 having a hole 35 located at one end. Bearing surfaces 36 are located on cover 10 in longitudinal alignment with the cams 33.

Equally however, the arrangement could be reversed and the cam based device 30 could be mounted on the cover 10 and inward extending bearing surfaces 36 provided on projections from the guide rails 13b and 14b in alignment with the cams 33. Such an arrangement has the advantage of removing cam based device 30 from spanning the opening at all times and therefore does not present a potential obstacle to the flow of material through the opening 2.

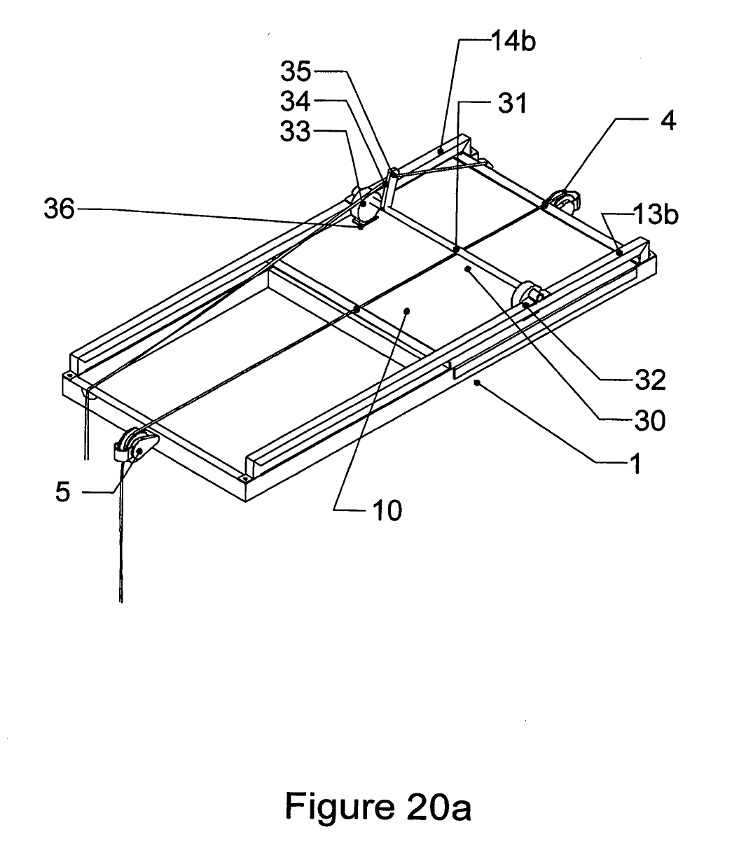

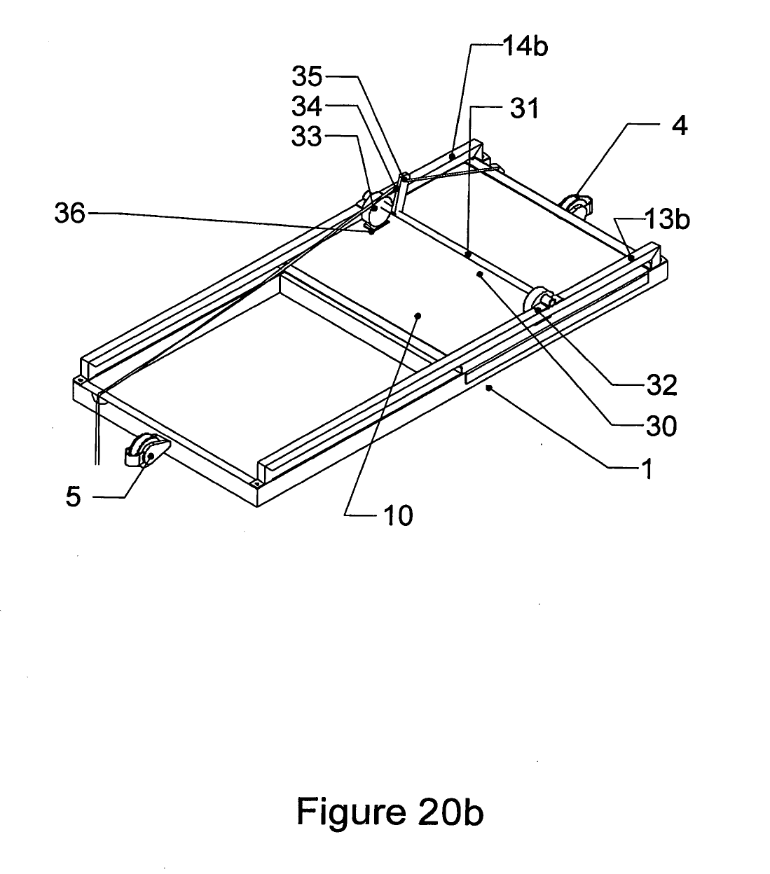

In either case, the rope is passed through hole 35 and secured to arm 34 so that its ends are remote of the apparatus (as shown in FIGS. 20a and 20b). Therefore it is possible to cause the cams 33 to rotate by pulling on either end of the rope which rotates the arms 34.

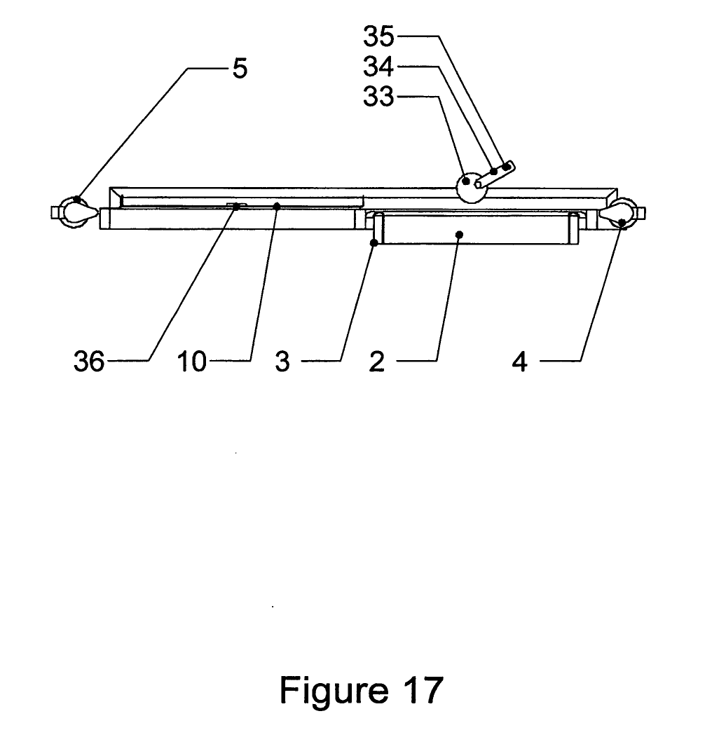

In FIGS. 16 and 17, the cover 10 is in the open position and cams 33 have been rotated so that their lowest surfaces are above the intended path of the cover 10. This is clear from FIG. 17.

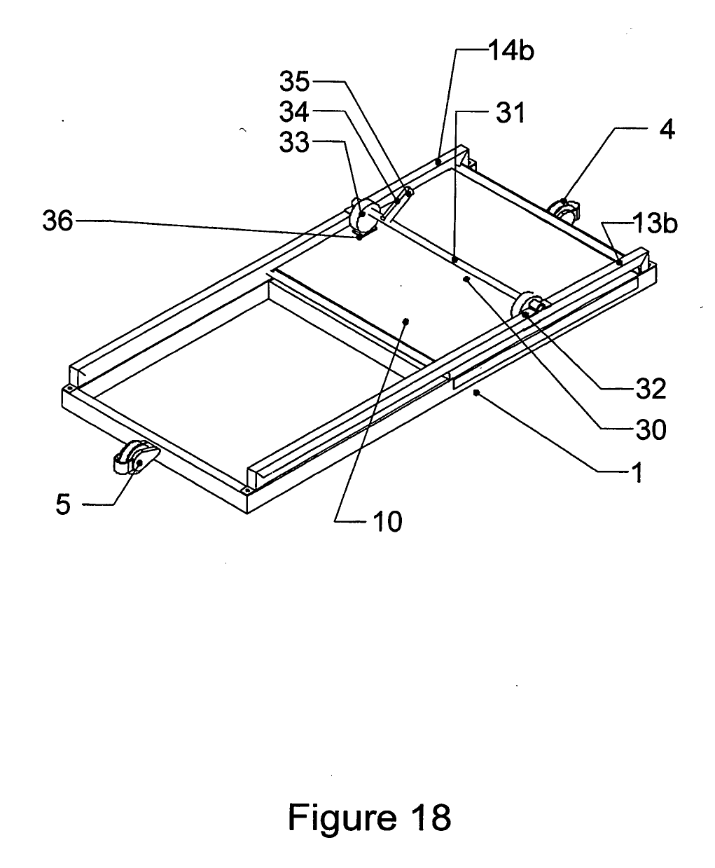

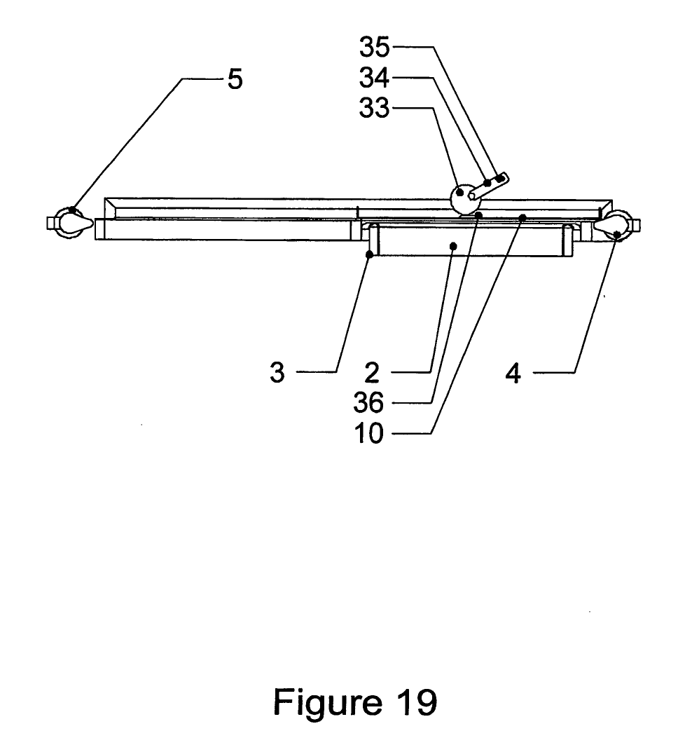

In FIGS. 18 and 19, the cover 10 has been moved into the closed position. Cams 33 have not been moved and are not in contact with cover 10. However, cams 33 are aligned with bearing surfaces 36. This is clear from FIG. 19.

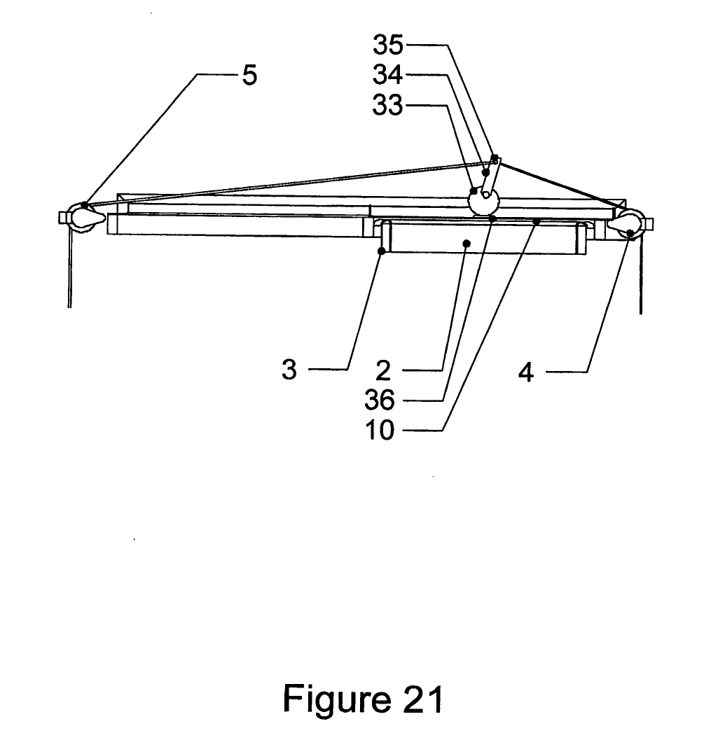

In FIGS. 20a, 20b and 21, the cover 10 is still in the closed position. However, by pulling on the rope, arm 25 is rotated in an anticlockwise direction. That movement causes cams 33 to rotate and engage bearing surfaces 36. Continuation of this rotation forces cover 10 down into sealing engagement with the rim 3 of opening 2 of the silo. This is clear from FIG. 21.

Reversal of this rotation will cause cover 10 to resile upward and cover 10 may then slide from the closed position to the open position.

The word ‘comprising’ and forms of the word ‘comprising’ as used in this description and in the claims does not limit the invention claimed to exclude any variants or additions.

1. A closure apparatus for covering an opening in a storage tank comprising:
(a) a connector to connect the apparatus to the silo in the proximity of the opening;
(b) a cover to cover the opening, said cover having a projection forming a leading edge of the cover,
(c) an elongate guide member having a guide surface, the cover being slidingly engaged with the guide member and movable along the guide surface from a first position adjacent the opening to a second position covering the opening; and
(d) an actuator to move the cover between the first position and the second position;
wherein the projection removes debris on the guide surface during movement between the first position and the second position.

2. The closure apparatus of claim 1 wherein the projection is juxtaposed to the guide surface to remove substantially all of the debris on the guide surface during movement of the cover.

3. The closure apparatus of claims 1 or 2 wherein the projection is aligned with and the approximate width of the guide surface.

4. The closure apparatus of claims 1 or 2 wherein projection extends across the width of the cover.

5. The closure apparatus of claim 1 wherein projection is integrally formed with of the cover.

6. The closure apparatus of claim 1 wherein the cover includes a sliding member slidingly engaged with the guide surface.

7. The closure apparatus of claim 6 wherein the sliding member has a sliding surface of low surface friction coefficient engaged with the guide surface.

8. The closure apparatus of claim 7 wherein the sliding member is comprised of a plastics material and the cover and guide surface comprised of metal material.

9. The closure apparatus of claim 8 wherein the sliding member is attached to the cover by a metal fastener and in use the metal fastener is spaced from the guide surface.

10. The closure apparatus of claim 6 wherein the sliding member is located operably behind the projection so that the projection will first contact any debris on the guide surface and thereafter the sliding member contacts and substantially removes the remaining smaller amount of debris.

11. The closure apparatus of claim 1, wherein the actuator is operated from a position remote of the cover and elongated guide member.

12. The closure apparatus of claim 11 wherein the actuator includes a pulley, a piston, a screw and/or a lever system.

13. The closure apparatus of claim 12 wherein the actuator is a pulley system comprised of two pulleys, each attached to opposite ends to the guide member, a flexible line passing through each pulley and crossing over the cover, and a mount on the cover attaching the cover to the line, such that by pulling on the line at either end, the cover is caused to move between the first and second position.

14. The closure apparatus of claim 13 wherein the flexible line is comprised of a synthetic (plastic) material or is coated with a synthetic (plastic) material.

15. The closure apparatus of claim 10 wherein the actuator is motorised and includes a remote activation switch.

16. The closure apparatus of claim 1 wherein the elongate guide member comprises a pair of generally parallel elongate guide rails spaced apart a distance of at least the diameter of the opening.

17. The closure apparatus of claim 16 wherein a complementary sub guide rail is located generally parallel with each of the guide rails and defines with that guide rail a longitudinal opening in which the cover is located to move between the first position and the second position.

18. The closure apparatus of claim 16 wherein the cover comprises at least one lateral projection along each edge thereof to slidingly engage about the elongate guide rail.

19. The closure apparatus of claim 18 wherein the lateral projection is adapted to engage a lower surface of the elongate guide member.

20. The closure apparatus of claim 1 further comprises a seal member to extend between the opening and the cover.

21. The closure apparatus of claim 1 further comprising a biasing member to urge the cover into sealed engagement with the opening.

22. The closure apparatus of claim 21 wherein the biasing member is operated from a position remote of the cover and elongated guide member.

23. The closure apparatus of claim 21 wherein the biasing member includes a cam mounted between the guide rails and moveable between a first position above the cover to a second position urging the cover into sealed engagement with the opening.

24. The closure apparatus of claim 21 wherein the biasing member includes a cam mounted on the cover and rotatable to engage the elongate guide member to urge the cover into sealed engagement with the opening.

25. The closure apparatus of claim 21 wherein the biasing member comprises, a plate, a resilient member and a seal, the plate being movably engaged with the underside of the cover, the seal being mounted on the plate and the resilient member being arranged so as to bias the plate towards the underside of the cover such that when the cover is in the second position, compression of the resilient means causes the plate and seal to form a sealing engagement with the opening.
